(19) United States
(12) Patent Application Publication
(10) Pub. No.: US 2018/0123782 A1
(43) Pub. Date: May 3, 2018

(54) METHOD FOR SECRET ORIGINATION SERVICE TO DISTRIBUTE A SHARED SECRET

(71) Applicant: MOTOROLA SOLUTIONS, INC., CHICAGO, IL (US)

(72) Inventor: THOMAS S. MESSERGES, SCHAUMBURG, IL (US)

(21) Appl. No.: 15/336,394

(22) Filed: Oct. 27, 2016

(51) Int. Cl. H04L 9/08; H04L 29/06

(52) U.S. Cl. CPC H04L 9/0819; H04L 63/0435; H04L 63/1466; H04L 9/0861

(57) ABSTRACT

A method and secret origination service are provided for calculating and distributing a shared secret. The secret origination service receives a first shared secret request from a first device. The first shared secret request includes a first identity token associated with a first user of the first device and a second participant identifier associated with a second user. The secret origination service verifies the first identity token to produce a first verified requestor identity and calculates a first shared secret based on the first verified requestor identity and the second user. The secret origination service sends the first shared secret to the first device. The secret origination service also receives a second shared secret request from the second device, which includes a second identity token associated with the second user of the second device and a first participant identifier associated with the first user. The secret origination service verifies the second identity token to produce a second verified requestor identity and calculates a second shared secret based on the second verified requestor identity and the first user. Because the inputs are the same, the second shared secret is identical to the first shared secret. The secret origination service sends the second shared secret to the second device.

### BACKGROUND OF THE INVENTION

Messages, such as text messages or chat messages, can be sent between two communication units. In most circumstances, each of the participants does not want the messages sent to be seen by anyone but the intended recipient.

A “man-in-the-middle attack” occurs when a third entity secretly relays and possibly alters the communication between two parties who believe they are directly communicating with each other.

Messages can be encrypted to prevent unauthorized reading of the messages, but if the method to establish the encryption key is susceptible to man-in-the middle attacks, then the man-in-the-middle can intercept, decrypt and read the messages between the two messaging participants.

Various approaches have been tried to deter these attacks. However, these approaches require large amounts of overhead and can be slow to implement. This can be a significant problem if the messaging participants have a need for near-instantaneous communication, such as in the public safety realm.

Therefore a need exists for a method of ensuring security and privacy between messaging participants without adding significant additional overhead or time delays for messages sent between the participants.

### BRIEF DESCRIPTION OF THE SEVERAL VIEWS OF THE DRAWINGS

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 is a system diagram illustrating a network in accordance with an exemplary embodiment of the present invention.

FIG. 2 illustrates a flow diagram setting forth a process for sending and receiving text messages using a shared secret in accordance with an exemplary embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Disclosed is an improved method and apparatus for distributing a shared secret by a secret origination service. The secret origination service receives a first shared secret request from a first device. The first shared secret request includes a first identity token associated with a first user of the first device and a second participant identifier (ID) associated with a second user. The secret origination service verifies the first identity token to produce a first verified requestor identity. The secret origination service calculates a first shared secret based on the first verified requestor identity and the identity of the second user and sends the first shared secret to the first device. The secret origination service also receives a second shared secret request that includes a second identity token associated with the second user of the second device and a first participant identifier associated with the first user from the second device. The secret origination service verifies the second identity token to produce a second verified requestor identity and calculates a second shared secret based on the second verified requestor identity and the identity of the first user. In accordance with an exemplary embodiment, the second shared secret is identical to the first shared secret. The secret origination service sends the second shared secret to the second device.

In this way man-in-the-middle attacks can be prevented by each device in a messaging communication receiving a shared secret that the man-in-the-middle does not know. The communicating devices can use the shared secret with various authentication protocols, such as the Socialist Millionaire protocol, to authenticate each other without exposing the key, thereby ensuring secure, private communications without the risk of exposing the shared key.

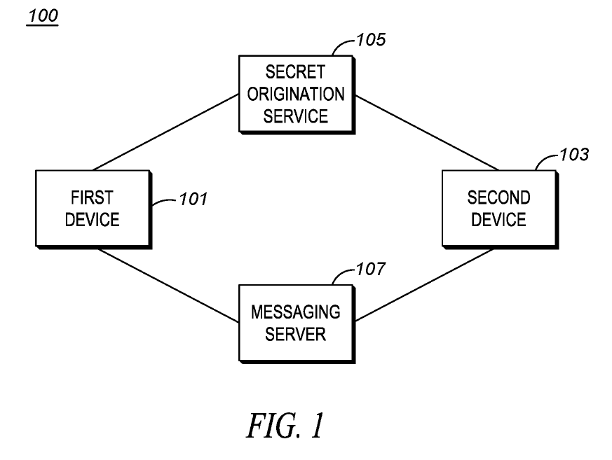

FIG. 1 is a system diagram illustrating a network 100 in accordance with an exemplary embodiment of the present invention. Network 100 preferably includes First Device 101, Second Device 103, Secret Origination Service 105, and Messaging Server 107.

First Device 101 and Second Device 103 are preferably mobile phones that can send and receive text messages over a radio frequency carrier while the user is moving within a telephone service area.

Secret Origination Service 105 is coupled to First Device 101, Second Device 103, and Messaging Server 107. Secret Origination Service 105 is a microservice that is able to verify an identity token. As used herein, a microservice is a process that communicates with other devices to accomplish a goal within network 100. Microservices are typically small software modules that utilize lightweight protocols. In according with an exemplary embodiment, Secret Origination Service 105 does not save or maintain any per-session state information. This increases the security of network 100.

In accordance with an exemplary embodiment, Secret Origination Service 105 exposes a Representational state transfer (REST) or RESTful web service interface that can be used by clients to obtain a shared secret useful for securing a communication session. For example, clients can securely connect to the Secret Origination Service 105 using the Secure HyperText Transfer Protocol (HTTPS). HTTPS provides for the encryption of exchanged information between the client and Secret Origination Service 105, where Secret Origination Service 105 authenticates itself to clients using a private key and a public-key certificate. This is the standard way virtually all websites, such as banks or e-commerce websites, are currently secured. The sensitive data maintained by Secret Origination Service 105 preferably includes a single master key for use in computing shared secrets and a private key for use in authenticating itself to clients during the HTTPS protocol session. Secret Origination Service 105 preferably computes a shared secret utilizing a Key Derivation Function (KDF). Secret Origination Service 105 preferably extracts a user identifier from an identity token and constructs a session string using the two users' identifiers and a time stamp. This session string is then used with the master key to compute the shared secret that first device 101 and second device 103 will receive from Secret Origination Service 105 and use to authenticate each other.

Messaging Server 107 is a middleware program that processes messages that are sent for use by other programs, preferably using a messaging application program interface (API). Messaging Server 107 typically queues and prioritizes messages as needed and saves each of the client programs from having to perform these services. The endpoints of a chat session, in this exemplary embodiment first device 101 and second device 103, rely on Messaging Server 107 to relay their chat messages. The encryption and authentication of the messages are handled at the endpoints, first device 101 and second device 103, thereby achieving end-to-end security. Messaging Server 107 never receives the shared secret, which allows for Messaging Server 107 to be deployed as a highly-scalable, public, cloud-based service that might not be fully trusted by the end users, such as Amazon Web Services. Secret Origination Service 105 maintains the sensitive keys critical to the security of the communication session, so Secret Origination Service 105 should be deployed in a secure environment, such as in an on-premise server owned, and fully trusted, by the system owners or on a more trusted cloud service provider, such as Amazon Web Services GovCloud.

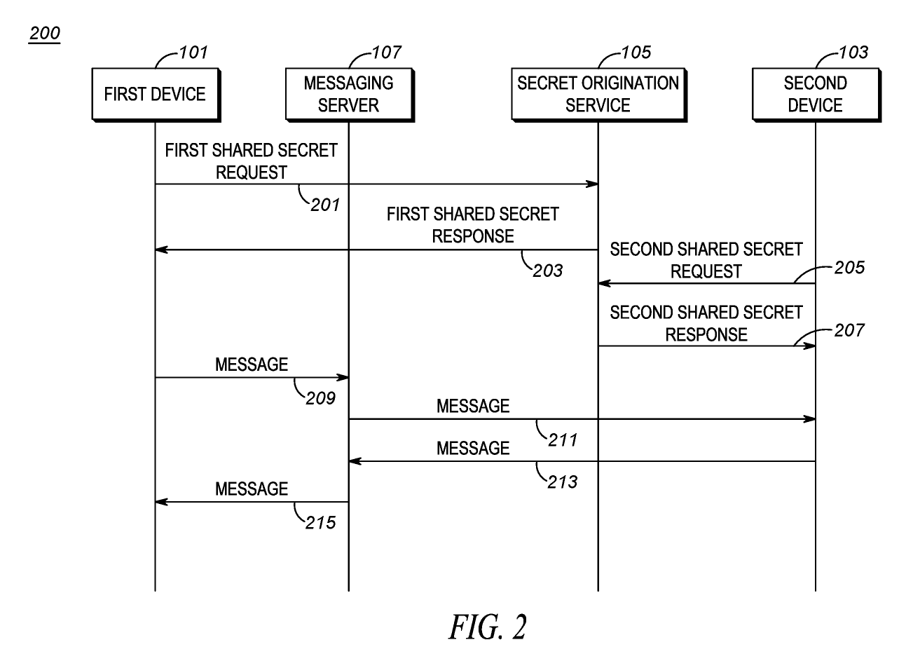

FIG. 2 illustrates a flow diagram 200 setting forth a process for sending and receiving text messages using a shared secret in accordance with an exemplary embodiment of the present invention. In accordance with an exemplary embodiment, all communications between entities in FIG. 2 are secured, for example using HTTPS.

First device 101 sends First Shared Secret Request message 201 to Secret Origination Service 105. First Shared Secret Request message 201 preferably includes an identity token associated with a first user of First Device 101 and an identifier associated with a second user of a Second Device 103 to which the first user of First Device 101 wishes to communicate.

Secret Origination Service 105 receives First Shared Secret Request message 201 and extracts the identity token and the identifier associated with a second user of Second Device 103 from First Shared Secret Request message 201. Secret Origination Service 105 verifies that the identity token is valid. If valid, then Secret Origination Service 105 uses the identity token to determine the identity of the first user of First Device 101 and uses the identifier associated with a second user of Second Device 103 to determine the identity of the second user of Second Device 103. Secret Origination Service 105 then verifies that the first and second users are allowed to receive a shared a secret and thereby ultimately establish a secure communication session, such as a chat session. If the identity token is valid and both users are allowed to receive a secret, Secret Origination Service 105 constructs a session string by concatenating, for example, the identifier associated with the first user of First Device 101, for example, as extracted from the identity token, the identifier associated with the second user of Second Device 103, and the time stamp. Secret Origination Service 105 calculates a secret, preferably utilizing the session string and the Master Key. In an exemplary embodiment, Secret Origination Service 105 uses a standardized Key Derivation Function (KDF), such as those defined by the National Institute of Standards and Technology (NIST) in their Special Publication 800-108, with the inputs to this KDF being the session string and the Master Key, to calculate the secret. Secret Origination Service 105 responds to First Device 101 with First Shared Secret Response message 203, which preferably includes the secret.

Second device 103 sends Second Shared Secret Request message 205 to Secret Origination Service 105. Second Shared Secret Request message 205 preferably includes an identity token associated with a second user of Second Device 103 and an identifier associated with a first user of First Device 101 to which the second user of Second Device 103 wishes to communicate.

Secret Origination Service 105 receives Second Shared Secret Request message 205 and extracts the identity token and the identifier associated with the first user of First Device 101 from Second Shared Secret Request message 205. Secret Origination Service 105 verifies that the identity token is valid. If valid, then Secret Origination Service 105 uses the identity token to determine the identity of the second user of Second Device 103 and uses the identifier associated with the first user of First Device 101 to determine the identity of the first user of First Device 101. Secret Origination Service 105 then verifies that the first and second users are allowed to receive a shared a secret and thereby ultimately establish a secure communication session, such as a chat session. If the identity token is valid and both users are allowed to receive a secret, Secret Origination Service 105 constructs a session string by concatenating, for example, the identifier associated with the first user of First Device 101, an identifier for Second Device 103, for example, as extracted from the identity token, and the time stamp. In accordance with an exemplary embodiment, Secret Origination Service 105 constructs the session string in a canonical form, such as alphabetical, so that the session string is the same whether the secret request originated from First Device 101 or Second Device 103. Secret Origination Service 105 calculates a secret, preferably utilizing the session string and the Master Key. In an exemplary embodiment, Secret Origination Service 105 uses a KDF, with the inputs to this KDF being the session string and the Master Key, to calculate the secret. Secret Origination Service 105 responds to Second Device 103 with Second Shared Secret Response message 207, which preferably includes the secret.

At this point in the exemplary embodiment, both First Device 101 and Second Device 103 possess the same secret, which is known only to them and to Secret Origination Service 105.

The identity tokens included within the first and second Shared Secret Request messages 201 and 205, respectively, are assumed to have been acquired prior to the flow diagram 200 depicted in FIG. 2. The identity tokens, such as a JSON web token, are preferably acquired from an identity provider (not shown). An identity token preferably corresponds to a particular user and it is the responsibility of the identity provider to perform a primary authentication of a user, such as a password or biometric scan, prior to providing the user's device with an identity token. The first and second users are able to get identity tokens sent to their devices, the identity tokens corresponding to the users' respective identities. Unless a third user is able to spoof the identity of either the first user or the second user, the third user will not be able to obtain an identity token corresponding to either the first user or the second user. As such, the third user cannot use a device to submit a Shared Secret Request message 201 or 205 to Secret Origination Service 105 and include a token for any user other than itself. Therefore, the third user will not be able to get the same shared secret as the first and second users on First Device 101 and Second Device 103, respectively.

It should be understood that the order in which First Device 101 and Second Device 103 obtain the secret is not important, and that Secret Origination Service 105 can reply to First Device 101 or Second Device 103 prior to receiving a request from the other device, or can receive two requests and then respond to each of the requests with a shared secret. As described in the above exemplary embodiment, the secret derived and distributed by Secret Origination Service 105 is calculated based on a session string comprising the identifiers of the user of First Device 101, the user of Second Device 103, and a time stamp, all put together into a canonical form. This string could be comprised using alternative components. For example, including the time stamp in this string provides a mechanism for the shared secret to periodically change. However, the time stamp is optional and could be left out, for example if there is no benefit to updating the shared secret. The interval at which the time stamp changes could also be modified to allow for faster or slower updates to the shared secrets.

In accordance with a further exemplary embodiment, First Device 101 requests a shared secret at time stamp N and Second Device 103 requests a shared secret at time stamp N+1. This results in each device getting a different shared secret. One solution to synchronize shared secrets would be for Secret Origination Service 105 to distribute two shared secrets whenever a request arrives within a pre-determined time interval to when the time stamp was updated. In this exemplary embodiment, First Device 101 and Second Device 103 negotiate which shared secret to use. Either secret could be used as long as the time between time stamps was less than a pre-determined threshold.

A further exemplary embodiment is for Secret Origination Service 105 to return the shared secret along with the time stamp. A device could share this time stamp with the other device(s) in which it needs to communicate. The other devices could provide Secret Origination Service 105 with a requested time stamp in their request for a shared secret. Secret Origination Service 105 would honor this requested time stamp, meaning that it uses the provided time stamp when calculating the secret that it distributes, only if time between the requested time stamp and current time stamp is less than a pre-determined threshold.

Once First Device 101 and Second Device 103 receive the same secret from Secret Origination Service 105, they can use this secret to help secure a communication session. In according with an exemplary embodiment, the secret is used directly as a cryptographic key for a symmetric-key encryption algorithm. Communications encrypted with this key would remain secure from outsiders. Even if a third entity were to get between First Device 101 and Second Device 103, the third entity would not be able to decrypt any messages sent between First Device 101 and Second Device 103 because the third entity does not know the secret, which was obtained outside of the messaging session.

If an attacker were to compromise Secret Origination Service 105, the sensitive keys it holds would be at risk of being exposed. If the attacker learns the master key, then all previous and future secrets distributed by Secret Origination Service 105 could be accessible to the attacker. If these secrets are directly used as a cryptographic key for a symmetric-key encryption algorithm to secure the communications between two users' devices, then these communications could also be decrypted and accessible to the attacker. Since past communications can be decrypted with the compromise of a long-term master key held by Secret Origination Service 105, the desirable security property known as “perfect forward secrecy” would not be achieved.

One solution to help regain perfect forward secrecy for the secure communication sessions is to periodically update the master key held by Secret Origination Service 105 and delete the old master key. Similar to when Secret Origination Service 105 updates the time stamp, updates to the master key preferably require a similar synchronization solution. In an exemplary embodiment, Secret Origination Service 105 provides an identifier of the master key along with each shared secret that it distributes. A device could share this identifier so that other devices can request a secret using the same master key. Secret Origination Service 105 preferably honors requests to use a previous master key when deriving the secret that it distributes only if the time since the master key changed is less than a predetermined interval.

To help keep past communications secured in the event of a successful attack on Secret Origination Service 105, another approach is to have the participants in the system not use directly the secrets that Secret Origination Service 105 distributes as a cryptographic key to secure the communications between two users. Instead, in an exemplary embodiment, the secrets distributed by Secret Origination Service 105 are exclusively used for authentication purposes and not for encryption purposes.

In an exemplary embodiment, Secret Origination Service 105 is seen within the context of secure messaging, oftentimes referred to as “texting” or a chat session, where end-to-end encryption of chat messages can be achieved using a protocol such as the Off-The-Record (OTR) protocol. The OTR protocol leverages the basic primitives defined in the Diffie-Hellman key establishment protocol, but is susceptible to man-in-the-middle attacks. One suggestion for detecting a man-in-the-middle attack during the OTR protocol is to make use of the Socialist Millionaire Protocol (SMP), which leverages a secret already shared between the two chat participants. The secret distributed by Secret Origination Service 105 is ideally suited for use as the shared secret needed by the SMP. In an exemplary embodiment, secure messaging participants execute the OTR protocol to establish a session key for encrypting messages, contact Secret Origination Service 105 to receive a common, shared secret, and use this common, shared secret for authentication purposes, such as by executing the SMP. The authentication steps are kept separate and independent from the OTR protocol. In this way, the security properties of the OTR protocol are preserved, while man-in-the-middle detection is achieved.

To summarize, First Device 101 and Second Device 103 first execute the OTR protocol to establish a session key. Next, First Device 101 and Second Device 103 both communicate with Secret Origination Service 105 to receive a common, shared secret. Finally, First Device 101 and Second Device 103 use this common shared secret with the SMP protocol to ensure that a man-in-the-middle is not present.

At some point the user of First Device 101 desires to send a message to the user of Second Device 103. It should be understood that user of Second Device 103 could send a message to the user of First Device 101 first, or that either user could be replying to a message previously sent by the other user. The user of First Device 101 sends Message 209 to Messaging Server 107. Message 209 preferably includes an identifier of the user of First Device 101, such as the user's identify token, the destination information, such as a device identifier, a user identifier or address, and the message content. The message content will be encrypted by First Device 101 with the session key established by the OTR protocol and verified to be shared only between devices 101 and 103 by the SMP protocol. In this exemplary embodiment the destination information is that of the user of Second Device 103.

Messaging Server 107 receives Message 209 and extracts the identifier of the user of First Device 101 and the destination information, but cannot decrypt the message content from Message 209. In accordance with an exemplary embodiment, Messaging Server 107 determines that the destination information refers to the user of Second Device 103 and then verifies that the user of First Device 101 can send a message to the user of Second Device 103.

If the user of First Device 101 is permitted to send messages to the user of Second Device 103, Messaging Server 107 sends the content of message 209 to Second Device 103 via Message 211. Second Device 103 preferably uses the session key to decrypt the message content from Message 211.

In a similar way, the user of Second Device 103 sends Message 213 to Messaging Server 107. Message 213 could be a reply to Message 209 or could be a new message. Messaging Server 107 verifies that the user of Second Device 103 is permitted to send messages to the user of First Device 101, and if so Messaging Server 107 sends Message 215 to First Device 101. Message 215 includes the content from Message 213.

In accordance with the foregoing, an improved method and apparatus for sending a shared secret to participants in a messaging communication is provided. A secret origination service, which is preferably a microservice, distributes shared secrets based upon the authorization of a requesting participant based on an identity token, the verified identifier of the requesting participant, the unverified identifier of the other chat participant, and a function that generates a shared secret. The inputs to the function preferably are the verified identifier of the requestor, and unverified identifier of the intended recipient, and a time code. The inputs are sent to the function in a predetermined order, thereby ensuring that the request for a shared secret from both participants will send the inputs to the function in the same order and will therefore receive the identical secret.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized electronic processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising an electronic processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

I claim:

1. A method for a secret origination service to distribute a shared secret comprising:
receiving a shared secret request from a device, the shared secret request comprising an identity token associated with a user of the device and a participant identifier associated with a second user;
verifying the identity token to produce a verified requestor identity;
calculating a shared secret based on the verified requestor identity and the participant identifier associated with the second user; and
sending the shared secret to the device.

2. The method of claim 1, wherein the step of calculating a shared secret comprises calculating a shared secret using a key derivation function.

3. The method of claim 2, wherein the step of calculating a shared secret using a key derivation function comprises calculating a shared secret using a key derivation function and a master key.

4. The method of claim 3, wherein the shared secret request further comprises a requested key identifier, and further comprising:
associating each master key with a key identifier;
periodically updating the master key and maintaining a record of the previous master keys;
verifying the requested key identifier is associated with the master key or a previous master key that was used within a predetermined time interval from the current time value; and
wherein the step of calculating a shared secret based on the verified requestor identity and the participant identifier associated with the second user comprises using a master key associated with the requested key identifier.

5. The method of claim 1, wherein the step of calculating a shared secret further comprises calculating a shared secret using a time value.

6. The method of claim 1, wherein the shared secret request further comprises a requested time value, the method further comprising:
determining a predetermined time interval;
determining if the requested time value is within the predetermined time interval; and
if the requested time value is within the predetermined time interval, the step of calculating a shared secret comprises calculating a shared secret based on the verified requestor identity, the participant identifier associated with the second user, and the requested time value.

7. A method for a first device to establish a secure session with a second device comprising:
sending a shared secret request from the first device to a secret origination service, the shared secret request comprising an identity token associated with a user of the first device and a participant identifier associated with a user of the second device;
receiving a shared secret at the first device from the secret origination service; and
using the shared secret with a cryptographic protocol to establish a secure session between the first device and the second device.

8. The method of claim 7, wherein the step of using the shared secret with a cryptographic protocol to establish a secure session between the first device and the second device comprises using the shared secret as a cryptographic key of a secure session between the first device and the second device.

9. The method of claim 7, wherein the step of using the shared secret with a cryptographic protocol to establish a secure session between the first device and the second device comprises using the shared secret as an authentication secret of a secure session between the first device and the second device.

10. The method of claim 9, wherein the step of using the shared secret as an authentication secret of a secure session between the first device and the second device comprises using the shared secret as the secret value as part of the Socialist Millionaire Protocol.

11. The method of claim 7, wherein the step of calculating a shared secret based on the verified requestor identity and the participant identifier associated with the second user comprises putting the verified requestor identity and the participant identifier associated with the second user in a canonical order.

12. A secret origination service comprising:
a receiver effective to receive a shared secret request from a device, the shared secret request comprising an identity token associated with a user of the device and a participant identifier associated with a second user; and
a processor effective to:
verify the identity token to produce a verified requestor identity;
calculate a shared secret based on the verified requestor identity and the participant identifier associated with the second user; and
a transmitter effective to send the shared secret to the device.

13. The secret origination service of claim 12, wherein the processor is effective to calculate the shared secret by calculating the shared secret using a key derivation function.

14. The secret origination service of claim 13, wherein the processor is effective to calculate the shared secret using a key derivation function by calculating the shared secret using a key derivation function and a master key.

15. The secret origination service of claim 12, wherein the processor is effective to calculate the shared secret by calculating the shared secret using a time value.

16. The secret origination service of claim 12, wherein the processor is effective to calculate the shared secret by calculating the shared secret using a first time value, and wherein the processor is effective to calculate a second shared secret using a second time value, and wherein the second time value matches the first time value if the secret origination service receives the second shared secret request within a predetermined time interval from receiving the shared secret request.

17. The secret origination service of claim 12, wherein the processor is effective to calculate the shared secret based on the verified requestor identity and the second user by putting the verified requestor identity and the second user in a canonical order, and wherein the processor is effective to calculate a second shared secret based on the second verified requestor identity and the first user by putting the second verified requestor identity and the first user in the canonical order.
